(19) United States
(12) Patent Application Publication
(10) Pub. No.: US 2014/0342045 A1
(43) Pub. Date: Nov. 20, 2014

(54) GLUTEN-FREE FLOUR BLEND

(71) Applicant: Deborah Mesdag, Dublin, OH (US)

(72) Inventor: Deborah Mesdag, Dublin, OH (US)

(21) Appl. No.: 14/215,557

(22) Filed: Mar. 17, 2014

Related U.S. Application Data
(60) Provisional application No. 61/791,744, filed on Mar. 15, 2013.
(60) Provisional application No. 61/837,816, filed on Jun. 21, 2013.

(51) Int. Cl. A23L 1/10; A23L 1/2165

(52) U.S. Cl. CPC A23L 1/1041; A23L 1/2165; A23V 2002/00
USPC 426/72; 426/622; 426/637

(57) ABSTRACT

A whole grain gluten-free flour blend for use by persons with celiac disease, gluten sensitivity, food allergies, autism spectrum disorder and others wishing to eliminate gluten from their diet. An embodiment of a whole grain gluten-free flour blend may comprise specified amounts of gluten-free whole-grain flours, other gluten-free flours, gluten-free starches, and may also include gluten-free gums and/or gluten-free vitamins and minerals. An example of this unique blend may approximate the taste, weight, texture and performance of wheat flour. Furthermore, in an exemplary embodiment, the flour may be used as a cup for cup substitute for all-purpose wheat flour in most conventional recipes.

This application claims the benefit of U.S. Provisional App. No. 61/791,744, filed Mar. 15, 2013, and U.S. Provisional App. No. 61/837,816, filed Jun. 21, 2013, each of which is hereby incorporated by reference in its entirety.

### BACKGROUND AND SUMMARY OF THE INVENTION

Exemplary embodiments of the present invention relate generally to baking products. More particularly, exemplary embodiments related to a gluten-free flour blend and related recipes and methods for its use.

Many people are intolerant of gluten. Other people simply desire to remove gluten from their diet for health or other reasons. As a result, there is a need for an improved gluten-free flour blend. For example, there is a need for a gluten-free flour blend that may be effectively used as a cup-for-cup substitute for wheat flour in traditional recipes. There is also a need for a fortified gluten-free flour blend. Exemplary embodiments of the present invention may satisfy one or more of the aforementioned needs.

In addition to the novel features and advantages mentioned above, other benefits will be readily apparent from the following descriptions of the drawings and exemplary embodiments.

### BRIEF DESCRIPTION OF THE DRAWINGS

FIG. 1 is a perspective view of an exemplary embodiment of a gluten-free flour blend.

### DETAILED DESCRIPTION OF EXEMPLARY EMBODIMENT(S)

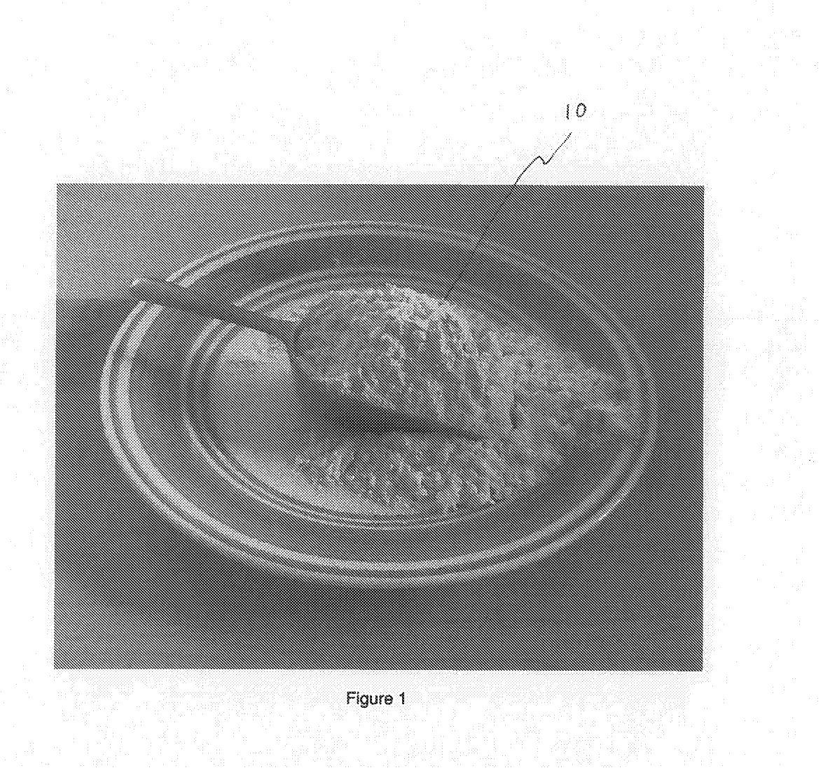

Exemplary embodiments of the present invention are directed to a gluten-free flour blend and related recipes and methods for its use. FIG. 1 shows an example of a gluten-free flour blend 10.

An exemplary embodiment of a whole grain gluten-free flour blend may approximate the taste, weight, texture and performance of wheat flour. Furthermore, an exemplary embodiment may be used as a cup for cup substitute for all-purpose wheat flour in most conventional recipes.

An example of a whole grain gluten-free flour blend 10 may comprise a combination of: whole grain gluten-free flours; other gluten-free flours; and gluten-free starches; wherein the combination is alone or in combination with one or more gluten-free gums and/or enrichment with one or more gluten-free vitamins and/or minerals. One exemplary embodiment of the whole grain gluten-free flour blend according to the present invention may generally comprise at least the following ingredients: 1) gluten-free sorghum flour; 2) gluten-free brown rice flour; 3) gluten-free millet flour; 4) gluten-free tapioca flour; 5) gluten-free potato starch; 6) gluten-free sweet rice flour; 7) gluten-free potato flour; 8) gluten-free xanthan gum; 9) gluten-free guar gum; and 10) one or more gluten-free vitamins and minerals.

Sorghum flour is a nutritious whole grain flour with a mild, slightly sweet flavor. It produces baked goods with excellent volume and texture when used in combination with other flours, starches and gums.

Brown rice flour is a whole grain flour made from unhulled rice kernals. It has a mildly sweet, nutty flavor; is high in protein and carbohydrate; and is a good source of B vitamins and fiber.

Millet flour is a whole grain flour that adds protein, fiber and essential vitamins and minerals to the flour blend. It gives baked goods a delicate, cake-like crumb.

Tapioca flour is a starch extracted from the cassava root. It gives structure to gluten-free baked goods and promotes browning while adding a crisp texture to a crust.

Potato starch is extracted from cooked, dried and ground potatoes. It helps bind the flour blend together and adds moistness to baked goods.

Sweet rice flour is milled short grain sticky rice. It has a mild, milky flavor. It acts as a binding agent and lightens baked goods.

Potato flour is ground from whole, dried potatoes. It gives baked goods a soft, moist texture and increases their shelf life.

Gums are hydrocolloids that thicken, bind and emulsify gluten-free baked goods. They provide structure similar to that which gluten gives to baked goods containing wheat. Xanthan gum is a polysaccharide that adds volume and viscosity to gluten-free baked goods by helping the starches combine and trap air. Guar gum is a galactomannan made from the seeds of guar beans. It is used in small amounts as a thickener, binder and volume enhancer. It has been discovered that it is desirable to use a combination of gums in order to avoid the negative effects that may occur when using a larger quantity of just one gum. Too much xanthan gum creates a gummy or slimy texture while too much guar gum produces heavy, dry baked goods. Used together, however, they surprisingly have a synergistic effect and each gum enhances the positive properties of the other. This effect produces baked goods with better structure that stay moist longer without being gummy.

The 2010 Dietary Guidelines for Americans recommend that everyone get at least half of their grains from whole grain sources and that the remaining grains be from enriched sources. Whole grains consist of the entire grain seed, which includes the bran, germ and endosperm. The sorghum, brown rice and millet flours in an exemplary embodiment of a whole grain, gluten-free flour blend are all whole grains. Each ¼ cup serving (33 g) of an example of this whole grain gluten-free flour blend includes a full serving (16 g) of whole grains when the percentage by weight of the flour blend is at least 49% whole grain flours.

In an exemplary embodiment, it is also desirable that at least some enrichment of certain vitamins and minerals be added to the flour blend. An example of this enrichment may include B vitamins, including thiamine, riboflavin, niacin, B6, B12, and folio acid for energy and a healthy nervous system; calcium and magnesium for bone health; iron to prevent anemia; or any combination of these ingredients.

An example of one embodiment of a whole grain gluten-free flour blend may comprise whole-grain gluten-free flours in an amount between 45% and 55% of a total weight of the flour blend. In an exemplary embodiment, the whole grain gluten-free flours may comprise gluten-free sorghum flour, gluten-free brown rice flour and gluten-free millet flour, with or without one or more other whole grain gluten-free flours. An example of the whole grain gluten-free flours may comprise: gluten-free sorghum flour in an amount between 35% and 55% of a total weight of the whole grain gluten-free flours; gluten-free brown rice flour in an amount between 25% and 45% of a total weight of the whole grain gluten-free flours; and gluten-free millet flour in an amount between 20% and 40% of a total weight of the whole grain gluten-free flours.

An example of a whole grain gluten-free flour blend may comprise the other gluten-free flours and gluten-free starches in an amount between 45% and 55% of a total weight of the flour blend. In an exemplary embodiment, the other gluten-free flours and gluten-free starches may comprise gluten-free tapioca flour, gluten-free potato starch, gluten-free sweet rice flour, and gluten-free potato flour, with or without other gluten-free flours and/or gluten-free starches. An example of the other gluten-free flours and gluten-free starches may comprise: gluten-free tapioca flour in an amount between 30% and 50% of a total weight of the other gluten-free flours and gluten-free starches; gluten-free potato starch in an amount between 18% and 33% of a total weight of the other gluten-free flours and the gluten-free starches; gluten-free sweet rice flour in an amount between 18% and 33% of a total weight of the other gluten-free flours and the gluten-free starches; and gluten-free potato flour in an amount between 2% and 12% of a total weight of the other gluten-free flours and the gluten-free starches.

An exemplary embodiment of a whole grain gluten-free flour blend may include one or more gluten-free gums in an amount of 0% to 4% of a total weight of the flour blend. In an exemplary embodiment, the one or more gluten-free gums may comprise gluten-free xanthan gum and/or gluten-free guar gum. An example of the gluten-free gums may comprise: gluten-free xanthan gum in an amount between 0% and 100% of a total weight of the one or more gluten-free gums, more preferably in an amount between 50% and 75% of a total weight of the one or more gluten-free gums; and/or gluten-free guar gum in an amount between 0% and 100% of a total weight of the one or more gluten-free gums, more preferably in an amount between 25% and 50% of a total weight of the one or more gluten-free gums.

An example of a whole grain gluten-free flour blend may further include one or more gluten-free vitamins and/or minerals in an amount between 0% and 4% of a total weight of the flour blend.

In an exemplary embodiment, the above listed flour ingredients are combined by weight to yield the present gluten free flour composition where the total equals 100%: 18% to 27% gluten-free sorghum flour, 13% to 21% gluten-free brown rice flour, 10% to 17% gluten-free millet flour, 15% to 24% gluten-free tapioca flour, 10% to 17% gluten-free potato starch, 10% to 17% gluten-free sweet rice flour, 1% to 6% gluten-free potato flour, 0% to 4% gluten-free xanthan gum, 0% to 4% gluten-free guar gum and 0% to 4% gluten-free vitamins and/or minerals with or without the addition of any other ingredients.

All the individual components may be blended together thoroughly in a commercial blender such as a double helix ribbon blender to create a uniform composition. The flour blend may then be packaged in dry form.

Having now fully set forth exemplary embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention.

What is claimed is:

1. A whole grain gluten-free flour blend comprising a combination of:
whole grain gluten-free flours;
other gluten-free flours; and
gluten-free starches;
wherein said combination is alone or in combination with one or more gluten-free gums and/or enrichment with gluten-free vitamins and/or minerals.

2. The whole grain gluten-free flour blend according to claim 1, wherein said whole-grain gluten-free flours comprise between 45% and 55% of a total weight of the flour blend.

3. The whole grain gluten-free flour blend according to claim 2, wherein said whole grain gluten-free flours comprise gluten-free sorghum flour, gluten-free brown rice flour and gluten-free millet flour, with or without one or more other whole grain gluten-free flours.

4. The whole grain gluten-free flour blend according to claim 3, wherein said gluten-free sorghum flour comprises between 35% and 55% of a total weight of the whole grain gluten-free flours.

5. The whole grain gluten-free flour blend according to claim 3, wherein said gluten-free brown rice flour comprises between 25% and 45% of a total weight of the whole grain gluten-free flours.

6. The whole grain gluten-free flour blend according to claim 3, wherein said gluten-free millet flour comprises between 20% and 40% of a total weight of the whole grain gluten-free flours.

7. The whole grain gluten-free flour blend according to claim 1, wherein said other gluten-free flours and said gluten-free starches comprise between 45% and 55% of a total weight of the flour blend.

8. The whole grain gluten-free flour blend according to claim 7, wherein said other gluten-free flours and said gluten-free starches comprise gluten-free tapioca flour, gluten-free potato starch, gluten-free sweet rice flour, and gluten-free potato flour, with or without other gluten-free flours and/or gluten-free starches.

9. The whole grain gluten-free flour blend according to claim 8, wherein said gluten-free tapioca flour comprises between 30% and 50% of a total weight of the other gluten-free flours and the gluten-free starches.

10. The whole grain gluten-free flour blend according to claim 8, wherein said gluten-free potato starch comprises between 18% and 33% of a total weight of the other gluten-free flours and the gluten-free starches.

11. The whole grain gluten-free flour blend according to claim 8, wherein said gluten-free sweet rice flour comprises between 18% and 33% of a total weight of the other gluten-free flours and the gluten-free starches.

12. The whole grain gluten-free flour blend according to claim 8, wherein said gluten-free potato flour comprises between 2% and 12% of a total weight of the other gluten-free flours and the gluten-free starches.

13. The whole grain gluten-free flour blend according to claim 1, wherein said one or more gluten-free gums comprise 0% to 4% of a total weight of the flour blend.

14. The whole grain gluten-free flour blend according to claim 13, wherein said one or more gluten-free gums comprise gluten-free xanthan gum and/or gluten-free guar gum.

15. The whole grain gluten-free flour blend according to claim 14, wherein said gluten-free xanthan gum comprises between 0% and 100% of a total weight of the one or more gluten-free gums.

16. The whole grain gluten-free flour blend according to claim 14, wherein said gluten-free xanthan gum comprises between 50% and 75% of a total weight of the one or more gluten-free gums.

17. The whole grain gluten-free flour blend according to claim 14, wherein said gluten-free guar gum comprises between 0% and 100% of a total weight of the one or more gluten-free gums.

18. The whole grain gluten-free flour blend according to claim 14, wherein said gluten-free guar gum comprises between 25% and 50% of a total weight of the one or more gluten-free gums.

19. The whole grain gluten-free flour blend according to claim 1, wherein said one or more gluten-free vitamins and/or minerals comprise between 0% and 4% of a total weight of the flour blend.

20. The whole grain gluten-free flour blend according to claim 1, comprising the following components by percentage of total weight, where the total equals 100%: 18% to 27% gluten-free sorghum flour, 13% to 21% gluten-free brown rice flour, 10% to 17% gluten-free millet flour, 15% to 24% gluten-free tapioca flour, 10% to 17% gluten-free potato starch, 10% to 17% gluten-free sweet rice flour, 1% to 6% gluten-free potato flour, 0% to 4% gluten-free xanthan gum, 0% to 4% gluten-free guar gum, and 0% to 4% gluten-free vitamins and/or minerals.
